(19) United States
(12) Patent Application Publication
(10) Pub. No.: US 2025/0358535 A1
(43) Pub. Date: Nov. 20, 2025

(54) SYSTEM AND METHOD FOR AI-GUIDED DYNAMIC CONFIGURATION AND EXECUTION OF MULTI-STEP OBJECT VERIFICATION WORKFLOWS

(71) Applicant: Prokta, Inc., Lewes, DE (US)

(72) Inventors: Goldee N. Udani, Bengaluru (IN); Himalaya Gupta, Bengaluru (IN)

(21) Appl. No.: 19/281,790

(22) Filed: Jul. 28, 2025

(51) Int. Cl. H04N 23/80; G06F 11/34; H04N 23/62

(52) U.S. Cl. CPC H04N 23/80; G06F 11/3452; H04N 23/62

(57) ABSTRACT

The present invention relates to a system for artificial intelligence (AI)-guided dynamic configuration and execution of multi-step object verification workflows. The system comprises a computing device operable in an administrator configuration mode for defining workflow definitions and in a user execution mode for initiating and executing workflows. The system supports receiving administrator-defined workflows comprising instructional metadata, validation requirements, and AI model references. Based on contextual identifiers such as user ID or fraud risk score, a session is initiated, and a workflow recipe is retrieved and rendered dynamically on the computing device without requiring application recompilation. The system validates user inputs using on-device AI models, determines workflow progression, and transmits validated data. Workflow variants, fallback logic, and contextual routing are supported. The system enables configurable, scalable, and AI-augmented object verification across various physical inspection use cases.

### FIELD OF THE INVENTION

The present disclosure relates generally to dynamic workflow management systems, and more particularly to a system and method for remotely defining, deploying, and executing adaptive, artificial intelligence (AI)-guided, multi-step data capture workflows for physical object verification across user-side applications.

### BACKGROUND

Workflow management systems have evolved significantly in recent decades, particularly across enterprise platforms, robotic process automation (RPA), and mobile ecosystems. Traditional systems primarily focus on automating sequences of digital or data-based tasks, such as document routing, approval chains, or software process orchestration. These systems are effective for predefined, rule-based flows, especially within enterprise software boundaries.

In such conventional settings, workflow configurations are typically authored by technical developers using design tools or scripting interfaces. The configurations are often embedded into source code or managed via static configuration files, requiring deployment cycles to update or modify. This architecture constrains the ability of non-technical users to make timely adjustments to logic, presentation, or validation steps, especially in dynamic operational contexts. In mobile-centric architectures that include client-server applications and client-execution framework-based systems, workflows are frequently hardcoded within the application binary. As a result, even minor updates to capture logic, visual guidance, or validation rules necessitate a full rebuild, quality assurance cycle, app store resubmission, and end-user app updates. This results in high latency and drastically slows down the realization of changes made in workflow systems.

Existing solutions also lack adaptive intelligence tailored to user-specific risk or context. For instance, in digital onboarding, e-commerce, or physical asset intake, all users typically undergo the same workflow steps regardless of trustworthiness. This static “one-size-fits-all” model introduces unnecessary friction for low-risk users and fails to adequately verify high-risk ones, compromising both user experience and fraud resilience. Additionally, most systems lack integrated mechanisms for empirical optimization, such as comparative testing across multiple workflow versions, thereby limiting data-driven enhancements.

Architecturally, prior art systems are limited in their ability to render dynamic, step-wise user interfaces on user's devices. The workflow UI and logic are often precompiled, offering minimal runtime flexibility. This limitation is especially apparent in applications requiring structured capture of physical object attributes, where rules or validation criteria evolve frequently. Moreover, traditional systems rarely support modular deployment or dynamic invocation of on-device artificial intelligence (AI) models at the granularity of individual workflow steps. For example, user-side frameworks often lack the ability to assign and execute specific AI checks, such as blur detection, occlusion analysis, or viewpoint classification, based on per-step requirements. Even when AI is used, it is generally baked into the application as a monolithic component, thereby precluding fine-grained control.

These limitations are exacerbated in domains involving physical object verification, where user guidance, camera framing, and environmental instructions must be precisely tuned. Existing workflows treat all data collection steps as generic tasks, without accounting for the nuances of condition assessment or visual documentation required in such contexts. Furthermore, conventional systems offer limited configurability to business stakeholders, thereby increasing development overhead and delaying time-to-market, especially in high-volume or regulated environments. There is typically no centralized administrative interface that enables non-technical users to design, test, and deploy workflow changes dynamically. As a result, even minor updates to workflow structure, instructions, or validation logic often require development involvement, thereby leading to elevated costs and prolonged rollout cycles.

To address the aforementioned limitations, there is a need for a system and method for remotely defining, deploying, and executing adaptive, artificial intelligence (AI)-guided, multi-step data capture workflows for physical object verification across user-side applications. There is also a need for a system that enables non-technical administrators to dynamically configure and deploy multi-step data capture workflows for inanimate physical object verification. There is also a need for a system to support real-time selection and deployment of on-device AI models on a per-step basis, thereby allowing tailored quality checks such as focus validation, occlusion detection, or seal integrity analysis during user-guided image capturing steps. Furthermore, the system should allow risk-based adaptation of workflows based on user profiles or fraud risk scores, support controlled deployment and comparative evaluation of multiple workflow variants for empirical optimization, and deliver a dynamic user-side experience without requiring application updates.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments nor delineate the scope of any or all embodiments.

The present disclosure, in one or more embodiments, relates to a system and method for remotely configuring and deploying adaptive, artificial intelligence (AI)-assisted, multi-step data capture workflows for physical object verification across user-side applications.

In one embodiment herein, the computing device comprises a processor and a memory configured to store one or more instructions executable by the processor. In one embodiment herein, the computing device is operable in an administrator configuration mode for defining and transmitting workflow definitions and in a user execution mode for initiating, rendering, and completing workflow sessions based on retrieved workflow recipes. In one embodiment herein, the computing device is in communication with a server and a database via a network. In one embodiment herein, the processor is configured for remotely defining, retrieving, rendering, validating, and executing configurable object verification workflows based on administrator-defined conditions.

In one embodiment herein, the processor is configured to receive one or more workflow definitions submitted by an authorized administrator via a workflow interface module via an administrative portal. In one embodiment herein, each of the one or more workflow definitions includes a sequence of image capturing steps, instructional metadata, validation requirements, optional or mandatory status indicators, and on-device AI model identifiers.

In one embodiment herein, the processor is configured to store each of the one or more workflow definitions as structured workflow recipes in the database using a recipe storage module. In one embodiment herein, each of the structured workflow recipes comprises image capturing step order, per-step transition conditions, AI model references, and output formatting schema.

In one embodiment herein, the processor is configured to receive and store multiple workflow variants using a workflow variant logic module, each workflow variant being associated with assignment rules based on user ID, fraud risk score, or contextual metadata entered by a user. In one embodiment herein, the workflow variant logic module is configured to conditionally assign different workflow variants to the user according to predefined distribution conditions for comparative performance evaluation across operational metrics. In one embodiment herein, the workflow variant logic module is configured to dynamically route user sessions to desired workflow variants based on distribution conditions, randomized segmentation, or fraud risk stratification thresholds. In one embodiment herein, the workflow variant logic module is configured to support fallback paths, which include early termination, manual override, or reassignment upon repeated validation failure.

In one embodiment herein, the processor is configured to initiate a workflow session using a session initiation module by transmitting one or more contextual identifiers entered by the user via a user interface module. In one embodiment herein, the one or more contextual identifiers include at least one of user identification (ID), an object category, a fraud risk score, or an operational variant indicator. In one embodiment herein, the session initiation module is configured to compute a fraud risk classification based on the contextual identifiers before selecting at least one workflow recipe.

In one embodiment herein, the processor is configured to retrieve the selected workflow recipe from the database via a recipe retrieval module based on the contextual identifiers. The selected workflow recipe comprises a sequential arrangement of image capturing steps with instructional metadata, which includes associated edge AI model references.

In one embodiment herein, the processor is configured to interpret the selected workflow recipe and dynamically construct a multi-step data capture interface on the computing device using a rendering module, without requiring recompilation or application-level updates. In one embodiment herein, the rendering module is configured to be implemented using a user-execution framework embedded within the computing device to support rendering without requiring application recompilation or redeployment. In one embodiment herein, the processor is configured to display dynamic, per-step instructional content, visual prompts, and capture guidance that is automatically generated from metadata defined in the workflow recipe using the user interface module.

In one embodiment herein, the processor is configured to capture one or more user inputs, which include images, and semi-structured data for each step, and validate the one or more user inputs using a capture and validation module by applying one or more on-device AI models referenced in the recipe. In one embodiment herein, the capture and validation module is configured to dynamically download and execute one or more on-device AI models using model identifiers defined in the selected workflow recipe. In one embodiment herein, the processor is configured to compile the validated data collected from completed workflow steps using a data compilation module into a structured format defined by the recipe's output schema.

In one embodiment herein, the processor is configured to determine workflow progression using a workflow logic module that is configured to evaluate the validation output and execute transition conditions that governs advancement, repetition, or redirection of steps based on validation. In one embodiment herein, the workflow logic module is configured to support conditional redirection or early workflow termination based on AI model validation scores or incomplete inputs. In one embodiment herein, the processor is configured to transmit a compiled dataset, which includes validated workflow outputs, to the server using a transmission module for downstream storage, grading, or comparison against reference data.

In one embodiment herein, the system enables non-technical administrators to remotely configure and deploy AI-assisted multi-step verification workflows for physical object assessment, supports dynamic user-side rendering and on-device validation without requiring application level-updates, and enables contextual workflow delivery based on user-specific session parameters. In one embodiment herein, the system is adapted to configure workflows for use cases, which include business-to-business inventory intake, product seal verification, or returns management.

According to an aspect, a method is disclosed for configuring and executing adaptive, artificial intelligence (AI)-guided, multi-step data capture workflows for physical object verification using the system. First, at one step, the workflow interface module receives the one or more workflow definitions from the authorized administrator via the administrative portal. Each workflow definition comprises the sequence of image capturing steps, instructional metadata, validation requirements, status indicators, and on-device AI model identifiers. At step 404, the recipe storage module stores the one or more workflow definitions and associated workflow variants as structured recipes in the database. In one embodiment herein, each of the workflow-structured recipes stored in the database includes image capturing step order, per-step transition conditions, display prompts, AI model references, and output formatting schema.

At another step, the workflow variant logic module assigns multiple workflow variants to a user based on one or more contextual identifiers entered by the user via the user interface module. The contextual identifiers include the user ID, the fraud risk score, and the contextual metadata. At another step, the session initiation module initiates the workflow session by transmitting the one or more contextual identifiers entered by the user to the server. At another step, the recipe retrieval module retrieves the selected workflow recipe from the database based on the contextual identifiers. In one embodiment herein, the contextual identifiers transmitted to the server include at least one of a user ID, object category, fraud risk score, or operational variant indicator.

At another step, the rendering module renders the multi-step data capture interface in real time based on the selected workflow recipe. In one embodiment herein, the rendering of the multi-step data capture interface is performed without requiring application recompilation or updates.

At another step, the user interface module displays dynamic instructional content, visual prompts, and capture guidance for each workflow step based on the metadata and configuration rules of the selected workflow recipe. In one embodiment herein, the user interface module generates and displays per-step guidance dynamically based on the metadata and validation requirements defined in the selected workflow recipe.

At another step, the capture and validation module captures and validates one or more user inputs for each workflow step, which include images and semi-structured data, by applying the one or more on-device AI models. In one embodiment herein, the capture and validation module dynamically downloads the one or more on-device AI models using the one or more contextual identifiers included in the workflow recipe.

At another step, the workflow logic module determines workflow progression based on validation outcomes using transition rules. In one embodiment herein, the workflow logic module governs workflow progression through advancement, repetition, redirection, or termination of workflow steps based on AI validation outcomes.

Further, at another step, the transmission module transmits the validated output data aggregated from completed workflow steps to the server for downstream operations, thereby enabling dynamic execution of AI-assisted object verification workflows based on user-specific contextual logic and without application updates. In one embodiment herein, the transmitted output data is formatted according to an output schema defined in the selected workflow recipe and is used for at least one of automated grading, archival, or comparison against reference data.

In another exemplary embodiment, a non-transitory computer-readable medium stores instructions that, when executed by a processor, cause the processor to perform a method for remotely configuring, deploying, and executing adaptive, artificial intelligence (AI)-guided, multi-step data capture workflows for physical object verification. In one embodiment herein, the method comprises several steps. Initially, the processor receives the one or more workflow definitions from the authorized administrator through the workflow configuration interface. Next, the processor stores each workflow definition and corresponding workflow variant as structured recipes in the database. Next, the processor receives the one or more contextual identifiers, which include at least one of user ID, object category, fraud risk score, or variant assignment indicator entered by the user via the user interface module in user execution mode for initiating the workflow session. Next, the processor retrieves the selected workflow recipe from the database based on the contextual identifiers. Next, the processor determines the dynamic multi-step data capture interface on the computing device using the selected workflow recipe, without requiring application recompilation or update. Next, the processor displays per-step instructional content and capture prompts based on the recipe metadata for each workflow step.

Next, the processor captures and validates one or more user inputs, including images, scans and semi-structured data fields, using one or more referenced on-device AI models. Next, the processor determines workflow progression based on validation outcomes and transition conditions defined in the recipe. Finally, the processor compiles and transmits the validated data to the server for downstream grading, storage, or reference comparison.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a block diagram of a system for artificial intelligence (AI)-guided dynamic configuration and execution of multi-step object verification workflows, by embodiments of the invention.

FIG. 2A illustrates a network flow diagram representing the configuration phase of the system, in accordance with embodiments of the invention.

FIG. 2B illustrates a network flow diagram representing the workflow session initiation and delivery phase of the system, in accordance with embodiments of the invention.

FIG. 2C illustrates a network flow diagram representing the execution, validation, and transmission phase of the system, in accordance with embodiments of the invention.

FIG. 3 illustrates a flowchart of a method for configuring and executing adaptive, AI-guided, multi-step data capture workflows for physical object verification using the system, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

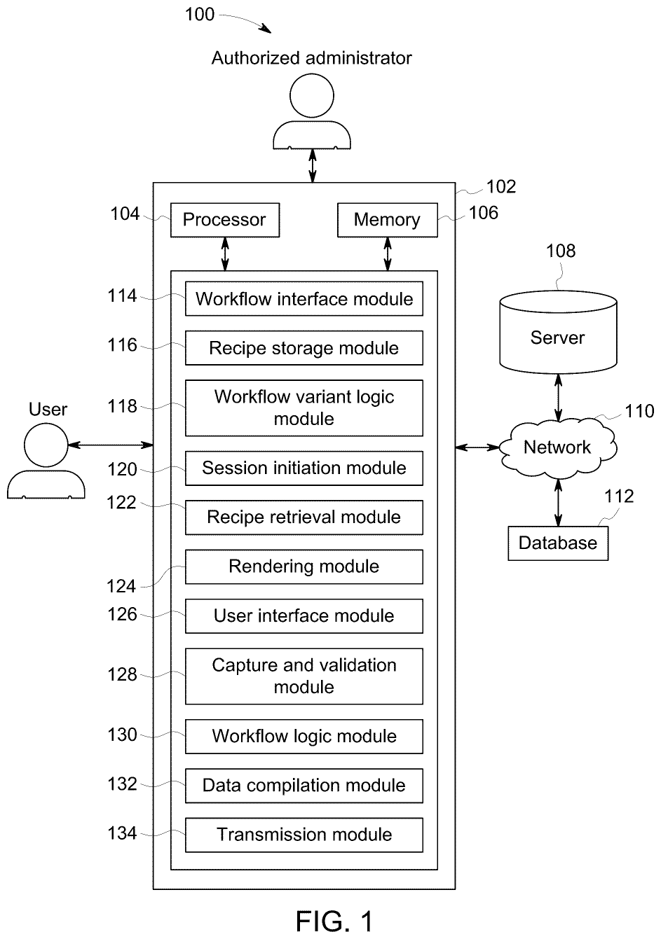

FIG. 1 refers to a block diagram of a system 100 for artificial intelligence (AI)-guided dynamic configuration and execution of multi-step object verification workflows. In one embodiment herein, the system 100 comprises a computing device 102 having a processor 104 and a memory 106, which stores one or more instructions executable by the processor 104. These instructions may be executed to cause the system 100 to perform the various functionalities. The processor 104 acts as the central processing unit (CPU) of the system 100, responsible for coordinating different tasks and carrying out complex operations, data processing, and decision-making by fetching instructions from the memory 106, thereby decoding the instructions and executing the necessary actions.

In one embodiment herein, the memory 106 serves as the storage component of the system 100, holding the executable instructions, as well as any data or information required by the processor 104 to perform its tasks. The data includes user inputs, system configurations, and any other relevant data needed for the system's operations. Through the communication between the processor 104 and the memory 106, the system 100 is able to process the user inputs, access stored information, perform computations, and make decisions accordingly.

In one embodiment herein, the computing device 102 represents any electronic device that the user can utilize to interact with the system 100. The computing device 102 can be, but is not limited to, a smartphone, a laptop, a tablet, a personal computer, or any other suitable electronic device. The computing device 102 serves as the user's gateway to accessing and interacting with the system 100. The computing device 102 is configured to enable the user and the administrator to engage with the system's functionalities and capabilities through a workflow interface module 114 and a user interface module 126.

In one embodiment herein, the workflow interface module 114 and the user interface module 126 are crucial components of the computing device 102, which allows the user and administrator to input commands, receive information, and control the system 100. The workflow interface module 114 and the user interface module 126 can be, but not limited to, a touch screen, a keyboard, a mouse, voice recognition modules, gesture recognition sensors, and virtual reality interfaces. The versatility of the workflow interface module 114 and the user interface module 126 ensures that the users can engage with the system 100 in a manner that is most intuitive and comfortable for the users, thereby catering to a wide range of user preferences and accessibility needs. The computing device 102 empowers the users to interact with the system 100 seamlessly and efficiently by providing multiple user interface options, thereby leveraging the most appropriate input and output modalities for their specific needs and preferences.

In one embodiment herein, the computing device 102 is in communication with a server 108 and a database 112 via a network 110. The network 110 acts as a communication that allows the computing device 102 to interact with the other components of the system 100, thereby facilitating the exchange of data, commands, and information. In one embodiment herein, the network 110 can be a wireless communication infrastructure, which offers the users flexibility and convenience when interacting with the system 100. This wireless connectivity enables the users to access the system 100 from various locations, without being tethered to a fixed physical connection.

In one embodiment herein, the network 110 can be, but is not limited to, a Local Area Network (LAN), Cellular Network, Wide Area Network (WAN), Intranet, Virtual Private Network (VPN), and wireless networks that use radio frequency (RF) or infrared (IR) technology to transmit data without the need for physical cables, thereby providing mobility and flexibility. The versatility of the network 110 ensures that the computing device 102 can seamlessly connect to the server 108 and the database 112, thereby enabling the users to access the functionalities and resources of the system 100 from a variety of locations and devices. This wireless connectivity enhances the overall accessibility and convenience of the system 100 for the users.

In one embodiment herein, the computing device 102 comprises the processor 104 and a memory 106 configured to store one or more instructions executable by the processor 104. In one embodiment herein, the computing device 102 is operable in an administrator configuration mode for defining and transmitting workflow definitions and in a user execution mode for initiating, rendering, and completing workflow sessions based on retrieved workflow recipes. In one embodiment herein, the computing device 102 is in communication with the server 108 and the database 112 via the network 110. In one embodiment herein, the processor 104 is configured for remotely defining, retrieving, rendering, validating, and executing configurable object verification workflows based on administrator-defined conditions.

In one embodiment herein, the processor 104 is configured to receive one or more workflow definitions submitted by an authorized administrator via the workflow interface module 114 via an administrative portal. In one embodiment herein, each of the one or more workflow definitions includes a sequence of image capturing steps, instructional metadata, validation requirements, optional or mandatory status indicators, and on-device AI model identifiers.

In one embodiment herein, the processor 104 is configured to store each of the one or more workflow definitions as structured workflow recipes in the database 112 using a recipe storage module 116. In one embodiment herein, each of the structured workflow recipes comprises image capturing step order, per-step transition conditions, AI model references, and output formatting schema.

In one embodiment herein, the processor 104 is configured to receive and store multiple workflow variants using a workflow variant logic module 118, each workflow variant being associated with assignment rules based on user ID, fraud risk score, or contextual metadata entered by a user. In one embodiment herein, the workflow variant logic module 118 is configured to conditionally assign different workflow variants to the user according to predefined distribution conditions for comparative performance evaluation across operational metrics. In one embodiment herein, the workflow variant logic module 118 is configured to dynamically route user sessions to desired workflow variants based on distribution conditions, randomized segmentation, or fraud risk stratification thresholds. In one embodiment herein, the workflow variant logic module 118 is configured to support fallback paths, which include early termination, manual override, or reassignment upon repeated validation failure.

In one embodiment herein, the processor 104 is configured to initiate a workflow session using a session initiation module 120 by transmitting one or more contextual identifiers entered by the user via the user interface module 126. In one embodiment herein, the one or more contextual identifiers include at least one of user identification (ID), an object category, a fraud risk score, or an operational variant indicator. In one embodiment herein, the session initiation module 120 is configured to compute a fraud risk classification based on the contextual identifiers before selecting at least one workflow recipe. In one embodiment herein, the session initiation module 120 interacts with a risk scoring engine hosted on the server 108, which classifies the user or session risk based on historical patterns or behavioral metadata, and accordingly retrieves a workflow recipe of appropriate complexity.

In one embodiment herein, the processor 104 is configured to retrieve the selected workflow recipe from the database via a recipe retrieval module 122 based on the contextual identifiers. The selected workflow recipe comprises a sequential arrangement of image capturing steps with the instructional metadata, which includes associated edge AI-model references.

In one embodiment herein, the processor 104 is configured to interpret the selected workflow recipe and dynamically construct a multi-step data capture interface on the computing device 102 using a rendering module 124, without requiring recompilation or application-level updates. In one embodiment herein, the rendering module 124 is configured to be implemented using a user-execution framework embedded within the computing device 102 to support rendering without requiring application recompilation or redeployment. In one embodiment herein, the processor 104 is configured to display dynamic, per-step instructional content, visual prompts, and capture guidance that is automatically generated from metadata defined in the workflow recipe using the user interface module 126.

In one embodiment herein, the processor 104 is configured to capture one or more user inputs, which include images, and semi-structured data for each step, and validate the one or more user inputs using a capture and validation module 128 by applying one or more on-device AI models referenced in the workflow recipe. In one embodiment herein, the capture and validation module 128 is configured to dynamically download and execute one or more on-device AI models using model identifiers defined in the selected workflow recipe.

In one embodiment herein, the processor 104 is configured to determine workflow progression using a workflow logic module 130 that is configured to evaluate the validation output and execute transition conditions that governs advancement, repetition, or redirection of steps based on validation. In one embodiment herein, the workflow logic module 130 is configured to support conditional redirection or early workflow termination based on AI model validation scores or incomplete inputs. In one embodiment herein, the processor 104 is configured to compile the validated data collected from completed workflow steps using a data compilation module 132 into a structured format defined by the recipe's output schema. In one embodiment herein, the processor 104 is configured to transmit a compiled dataset, which includes validated workflow outputs, to the server 108 using a transmission module 134 for downstream storage, grading, or comparison against reference data.

In one embodiment herein, the system 100 enables non-technical administrators to remotely configure and deploy AI-assisted multi-step verification workflows for physical object assessment, supports dynamic user-side rendering and on-device validation without requiring application level-updates, and enables contextual workflow delivery based on user-specific session parameters. In one embodiment herein, the system 100 is adapted to configure workflows for use cases, which include business-to-business inventory intake, product seal verification, or returns management.

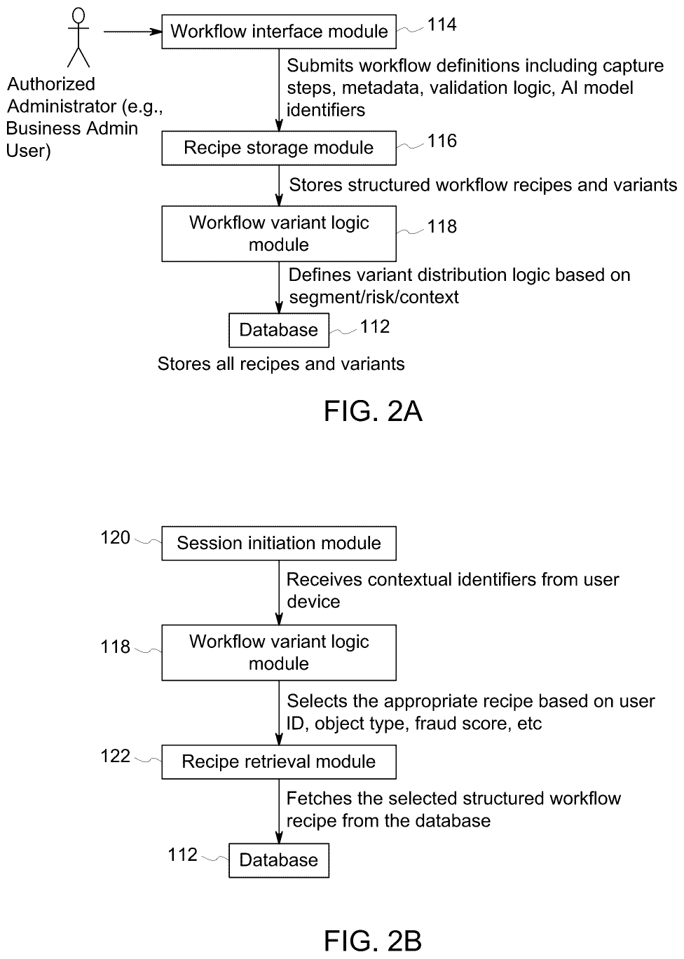

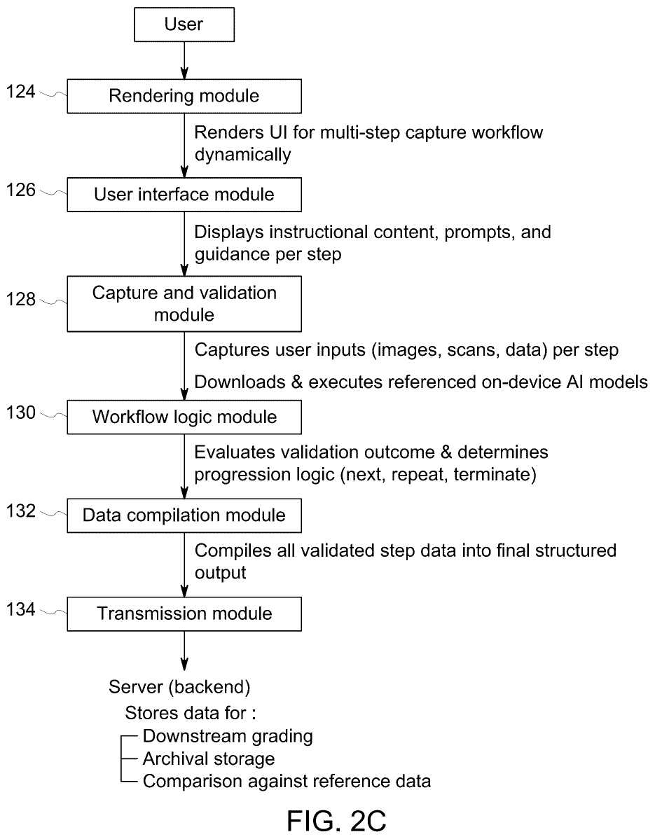

FIG. 2A refers to a network flow diagram representing the configuration phase of the system 100. In FIG. 2A, the authorized administrator interacts with the administrative portal hosted in a secure cloud or enterprise backend environment. This administrative portal incorporates the workflow interface module 114, through which the administrator defines one or more workflow definitions. Each workflow definition includes the sequential arrangement of image capturing steps, instructional metadata, validation criteria, mandatory or optional step indicators, and references to downloadable on-device AI model identifiers. These workflow definitions are parsed and stored using the recipe storage module 116 into the database 112 as structured workflow recipes, which encapsulate the logic and metadata needed to dynamically construct data capture sessions on the client or user side. In one embodiment herein, the workflow recipe comprises one or more conditional branches that dynamically skip, repeat, or reorder steps based on real-time user input or AI validation results. In one embodiment herein, the workflow recipe further includes fallback rules that redirect the user to simplified workflows upon repeated AI validation failures or user dropout.

Additionally, the workflow variant logic module 118 enables the authorized administrator to define and associate multiple workflow variants with assignment rules based on real-time attributes such as fraud risk scores, user types, operational modes, or object categories. This allows the system 100 to assign different variants conditionally for experimentation, tuning, or fallback logic, e.g., assigning stricter verification paths to higher-risk users. The stored variants are persisted alongside the primary recipes in the database 112, thereby enabling dynamic and contextual recipe retrieval at runtime.

FIG. 2B refers to a network flow diagram representing the workflow session initiation and delivery phase of the system 100. As shown in FIG. 2B, the user operating the computing device 102 embedded with the user-execution framework initiates the workflow session. The user-execution framework collects contextual identifiers, including, but not limited to, user ID, object category, variant assignment indicator, and dynamically computed or externally retrieved fraud risk classification scores. These contextual identifiers are transmitted to the server 108 through a secure application programming interface (API) endpoint, where they are processed by the session initiation module 120.

Based on the received identifiers, the recipe retrieval module 122 queries the database 112 and selects at least one workflow recipe that satisfies the contextual constraints and variant routing rules. The selected workflow recipe is streamed back to the computing device 102 via the API endpoint. On the user side, the rendering module 124 dynamically constructs the multi-step data capture interface in real-time, using the step definitions and UI metadata defined in the recipe. This eliminates the need for application recompilation or updates, thus supporting agile deployment of modified workflows without user disruption.

FIG. 2C refers to a network flow diagram representing the execution, validation, and transmission phase of the system 100. As shown in FIG. 2C, during the execution of the workflow session, the user interface module 126 displays per-step visual prompts, instructional overlays, or scanning guides, all rendered in accordance with the metadata associated with each workflow step. The user inputs data through various modes, such as image capture, barcode scanning, or structured field entry, which is processed by the capture and validation module 128.

The capture and validation module 128 invokes one or more on-device AI models, referenced in the workflow recipe, to perform real-time validation. These on-device AI models may execute operations such as object presence detection, label alignment checking, seal integrity classification, damage detection, or orientation assessment. The workflow logic module 130 monitors the validation outcomes and enforces transition rules, thereby allowing the user to proceed to the next step, retry the current one, or exit early based on dynamic conditions such as model confidence scores or validation errors.

Once all required steps have been successfully validated, the data compilation module 132 aggregates the step-wise data and formats it into a structured schema defined within the workflow recipe. This compiled dataset is transmitted via the transmission module 134 to the server 108, thereby enabling downstream operations such as automated grading, reference-based comparison, audit logging, archival storage, or integration with external enterprise systems for quality control, fraud prevention, or workflow analytics.

The system 100 empowers non-technical administrators to configure verification workflows remotely and execute them dynamically on computing devices. This allows contextual customization, secure data processing, and high scalability across diverse industrial use cases, including logistics intake, warranty return processing, resale quality verification, insurance assessments, and anti-counterfeiting operations.

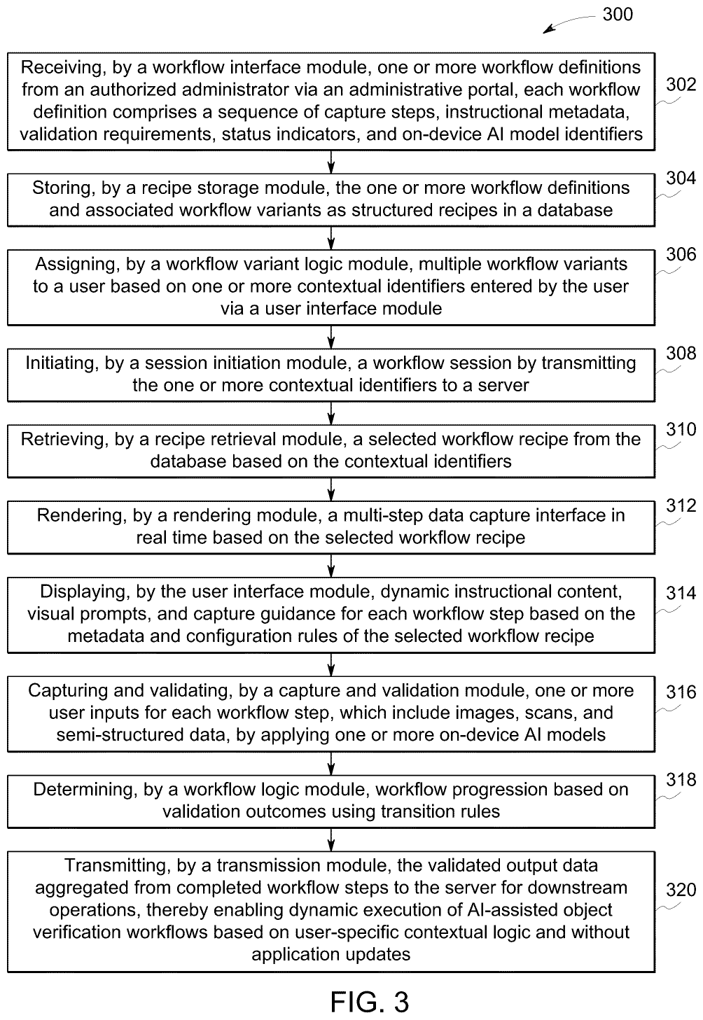

FIG. 3 refers to a flowchart 300 of a method for configuring and executing adaptive, artificial intelligence (AI)-guided, multi-step data capture workflows for physical object verification using the system 100. First, at step 302, the workflow interface module 114 receives the one or more workflow definitions from the authorized administrator via the administrative portal. Each workflow definition comprises the sequence of image capturing steps, instructional metadata, validation requirements, status indicators, and on-device AI model identifiers. At step 304, the recipe storage module 116 stores the one or more workflow definitions and associated workflow variants as structured recipes in the database 112. In one embodiment herein, each of the workflow-structured recipes stored in the database 112 includes image capturing step order, per-step transition conditions, display prompts, AI model references, and output formatting schema.

At step 306, the workflow variant logic module 118 assigns multiple workflow variants to the user based on one or more contextual identifiers entered by the user via the user interface module 126. The contextual identifiers include user ID, fraud risk score, or contextual metadata. At step 308, the session initiation module 120 initiates the workflow session by transmitting the one or more contextual identifiers to the server 108. At step 310, the recipe retrieval module 122 retrieves the selected workflow recipe from the database 112 based on the contextual identifiers. In one embodiment herein, the contextual identifiers include at least one of the user ID, object category, fraud risk score, or operational variant indicator.

At step 312, the rendering module 124 renders the multi-step data capture interface in real time based on the selected workflow recipe. In one embodiment herein, the rendering of the multi-step data capture interface is performed without requiring application recompilation or updates.

At step 314, the user interface module 126 displays dynamic instructional content, visual prompts, and capture guidance for each workflow step based on the metadata and configuration rules of the selected workflow recipe. In one embodiment herein, the user interface module generates and displays per-step guidance dynamically based on the metadata and validation requirements defined in the selected workflow recipe.

At step 316, the capture and validation module 128 captures and validates one or more user inputs for each workflow step, which include images and semi-structured data, by applying the one or more on-device AI models. In one embodiment herein, the capture and validation module 128 dynamically downloads the one or more on-device AI models using the one or more contextual identifiers included in the workflow recipe.

At step 318, the workflow logic module 130 determines workflow progression based on validation outcomes using transition rules. In one embodiment herein, the workflow logic module 130 governs workflow progression through advancement, repetition, redirection, or termination of workflow steps based on AI validation outcomes.

Further, at step 320, the transmission module 132 transmits the validated output data aggregated from completed workflow steps to the server 108 for downstream operations, thereby enabling dynamic execution of AI-assisted object verification workflows based on user-specific contextual logic and without application updates. In one embodiment herein, the transmitted output data is formatted according to an output schema defined in the selected workflow recipe and is used for at least one of automated grading, archival, or comparison against reference data.

In another exemplary embodiment, a non-transitory computer-readable medium stores instructions that, when executed by the processor 104, cause the processor 104 to perform a method for remotely configuring, deploying, and executing adaptive, artificial intelligence (AI)-guided, multi-step data capture workflows for physical object verification. In one embodiment herein, the method comprises several steps. Initially, the processor 104 receives one or more workflow definitions from the authorized administrator through the workflow configuration interface. Next, the processor 104 stores each workflow definition and corresponding workflow variant as structured recipes in the database 112 with a configurable TTL (Time to Live). This will enable the system 100 to refresh the changes if required. Next, the processor 104 receives the one or more contextual identifiers, which include at least one of the user ID, object category, fraud risk score, or variant assignment indicator entered by the user via the user interface module 126 for initiating the workflow session. Next, the processor 104 retrieves the selected workflow recipe from the database 112 based on the contextual identifiers. Next, the processor 104 determines the dynamic multi-step data capture interface on the computing device 102 using the selected workflow recipe, without requiring application recompilation or update. Next, the processor 104 displays per-step instructional content and capture prompts based on the recipe metadata for each workflow step.

Next, the processor 104 captures and validates one or more user inputs, including images and semi-structured data, using one or more referenced on-device AI models. Next, the processor 104 determines workflow progression based on validation outcomes and transition conditions defined in the recipe. Finally, the processor 104 compiles and transmits the validated data to the server 108 for downstream grading, storage, or reference comparison.

In one embodiment herein, the administrative portal is a no-code interface configured to allow non-technical users to define workflow logic and deployment rules via graphical input. In one embodiment herein, the workflow recipe includes identifiers for specific versions of on-device AI models to be dynamically downloaded and applied for individual image capturing steps, enabling step-specific validation. In one embodiment herein, the administrative portal provides a no-code or low-code graphical interface for configuring workflows by selecting components from a visual palette and defining rule sets through parameter-based forms, thereby eliminating the need for traditional programming.

In one embodiment herein, the system 100 enables dynamic invocation and secure downloading of specific AI models defined within the workflow recipe, allowing user devices to validate physical object attributes like angle, occlusion, or seal integrity using on-device inference engines. In cases of download failure, fallback models or manual verification steps may be used. In another embodiment herein, the system 100 supports workflows for business-to-business inventory intake audits, where the administrator may configure simplified, fast-track workflows optimized for trained warehouse personnel. For return verifications, the workflow may involve multi-angle imaging of seals and AI-based seal authenticity verification to determine refund eligibility. In one embodiment herein, the system 100 records performance metrics such as user drop-off rate, validation success rate, and fraud detection rate per variant to enable post-deployment analysis, thereby allowing administrators to select optimal workflows based on empirical data. In one embodiment herein, all data exchanged between the user, the server 108, and administrator portal is encrypted using secure transmission protocols, thereby ensuring compliance with data protection standards during model download, user input capture, and output upload.

In one embodiment herein, the system 100 provides a backend infrastructure allowing non-technical administrators to define, update, and deploy multi-step object capture and verification workflows remotely via the administrative portal without needing app recompilation or updates. The system 100 is configured to dynamically download, load, and execute specific on-device AI models (e.g., occlusion detection, 3D angle validation) per workflow step to ensure real-time input quality and contextual guidance. The system 100 is configured to dynamically render multi-step UI components based on retrieved workflow recipes on the user-execution framework, thereby ensuring flexibility in interface delivery without hardcoded steps.

The system 100 is configured to automatically assign and adapt workflow variants to users based on contextual identifiers such as risk profile, object type, or user ID. The system 100 is configured to allow multiple workflow variants to be deployed and evaluated simultaneously, with built-in logic to assess performance across key metrics like fraud detection, user drop-off, and data quality. The system 100 is configured to provide a flexible system architecture capable of supporting diverse use cases like C2C listings, B2B inventory audits, product return validation, and warranty fraud detection. The system 100 is configured to offer a lightweight user-execution framework that integrates with user applications for rendering, validation, and submission of object data workflows without disrupting existing user flows.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A system for artificial intelligence (AI)-guided dynamic configuration and execution of multi-step object verification workflows, comprising:
a computing device having a processor and a memory configured to store one or more instructions executable by the processor,
wherein the computing device is operable in an administrator configuration mode for defining and transmitting workflow definitions, and in a user execution mode for initiating, rendering, and completing workflow sessions based on retrieved workflow recipes, wherein the computing device is in communication with a server and a database via a network,
wherein the processor is configured for remotely defining, retrieving, rendering, validating, and executing configurable object verification workflows based on administrator-defined conditions,
wherein the processor is configured to:
receive one or more workflow definitions submitted by an authorized administrator via a workflow interface module through an administrative portal, wherein each of the one or more workflow definitions include a sequence of image capturing steps with instructional metadata, validation requirements, optional or mandatory status indicators, and on-device AI model identifiers;
store each of the one or more workflow definitions as structured workflow recipes in the database using a recipe storage module, wherein each of the structured workflow recipes comprises image capturing step order, per-step transition conditions, AI model references, and output formatting schema;
initiate a workflow session using a session initiation module by transmitting one or more contextual identifiers entered by a user via a user interface module, wherein the one or more contextual identifiers include at least one of a user identification (ID), an object category, a fraud risk score, and an operational variant indicator;
retrieve a selected workflow recipe from the database via a recipe retrieval module based on the contextual identifiers, wherein the selected workflow recipe comprises a sequential arrangement of the image capturing steps with the instructional metadata, which includes associated edge AI model references;
interpret the selected workflow recipe and dynamically construct a multi-step data capture interface on the computing device using a rendering module without requiring recompilation and application-level updates;
capture one or more user inputs, which include images, and semi-structured data for each workflow step, and validate the one or more user inputs using a capture and validation module by applying the one or more on-device AI models referenced in the workflow recipe;
determine workflow progression using a workflow logic module that is configured to evaluate the validation output and execute transition conditions that governs advancement, repetition, or redirection of workflow steps based on validation; and
transmit a compiled dataset, which includes validated workflow outputs, to the server using a transmission module for downstream storage, grading, or comparison against reference data,
wherein the system is configured to enable non-technical administrators to remotely configure and deploy AI-assisted multi-step verification workflows for physical object assessment, supports dynamic user-side rendering and on-device validation without requiring the application-level updates, and enables contextual workflow delivery based on user-specific session parameters.

2. The system for AI-guided dynamic configuration and execution of multi-step object verification workflows of claim 1, wherein the processor is configured to receive and store multiple workflow variants using a workflow variant logic module, wherein each of the workflow variants is associated with assignment rules based on the user ID, the fraud risk score, and contextual metadata.

3. The system for AI-guided dynamic configuration and execution of multi-step object verification workflows of claim 2,
wherein the workflow variant logic module is configured to conditionally assign different workflow variants to users according to predefined distribution conditions for comparative performance evaluation across operational metrics,
wherein the workflow variant logic module is configured to dynamically route user sessions to desired workflow variants based on distribution conditions, randomized segmentation, or fraud risk stratification thresholds,
wherein the workflow variant logic module is configured to support fallback paths, which include early termination, manual override, or reassignment upon repeated validation failure.

4. The system for AI-guided dynamic configuration and execution of multi-step object verification workflows of claim 1, wherein the capture and validation module is configured to dynamically download and execute the one or more on-device AI model identifiers defined in the selected workflow recipe.

5. The system for AI-guided dynamic configuration and execution of multi-step object verification workflows of claim 1, wherein the rendering module is configured to be implemented using a user-execution framework embedded within the computing device to support rendering without requiring application recompilation or redeployment.

6. The system for AI-guided dynamic configuration and execution of multi-step object verification workflows of claim 1, wherein the processor is configured to display dynamic, per-step instructional content, visual prompts, and capture guidance that is automatically generated from metadata defined in the workflow recipe using the user interface module.

7. The system for AI-guided dynamic configuration and execution of multi-step object verification workflows of claim 1, wherein the session initiation module is configured to compute a fraud risk classification based on the contextual identifiers before selecting a workflow recipe.

8. The system for AI-guided dynamic configuration and execution of multi-step object verification workflows of claim 1, wherein the workflow logic module is configured to support conditional redirection or early workflow termination based on AI model validation scores or incomplete inputs.

9. The system for AI-guided dynamic configuration and execution of multi-step object verification workflows of claim 1, wherein the processor is configured to compile the validated data collected from completed workflow steps using a data compilation module into a structured format defined by the recipe's output schema.

10. The system for AI-guided dynamic configuration and execution of multi-step object verification workflows of claim 1, wherein the system is adapted to configure workflows for use cases, which include business-to-business inventory intake, product seal verification, or returns management.

11. A method for configuring and executing adaptive, artificial intelligence (AI)-guided, multi-step data capture workflows for physical object verification using a system, comprising:
receiving, by a workflow interface module, one or more workflow definitions from an authorized administrator via an administrative portal, each workflow definition comprises a sequence of image capturing steps, instructional metadata, validation requirements, status indicators, and on-device AI model identifiers;
storing, by a recipe storage module, the one or more workflow definitions and associated workflow variants as structured recipes in a database;
assigning, by a workflow variant logic module, multiple workflow variants to a user based on one or more contextual identifiers entered by the user via a user interface module;
initiating, by a session initiation module, a workflow session by transmitting the one or more contextual identifiers to a server;
retrieving, by a recipe retrieval module, a selected workflow recipe from the database based on the contextual identifiers;
rendering, by a rendering module, a multi-step data capture interface in real time based on the selected workflow recipe;
displaying, by the user interface module, dynamic instructional content, visual prompts, and capture guidance for each workflow step based on the metadata and configuration rules of the selected workflow recipe;
capturing and validating, by a capture and validation module, one or more user inputs for each workflow step, which include images, scans, and semi-structured data, by applying one or more on-device AI models;
determining, by a workflow logic module, workflow progression based on validation outcomes using transition rules; and
transmitting, by a transmission module, the validated output data aggregated from completed workflow steps to the server for downstream operations, thereby enabling dynamic execution of AI-assisted object verification workflows based on user-specific contextual logic and without application updates.

12. The method of claim 11, wherein the contextual identifiers transmitted to the server include at least one of a user ID, object category, fraud risk score, or operational variant indicator.

13. The method of claim 11, wherein each of the workflow structured recipes stored in the database includes image capturing step order, per-step transition conditions, display prompts, AI model references, and output formatting schema.

14. The method of claim 11, wherein the rendering of the multi-step data capture interface is performed without requiring application recompilation or updates.

15. The method of claim 11, wherein the user interface module generates and displays per-step guidance dynamically based on the metadata and validation requirements defined in the selected workflow recipe.

16. The method of claim 11, wherein the capture and validation module dynamically downloads the one or more on-device AI models using the one or more contextual identifiers included in the workflow recipe.

17. The method of claim 11, wherein the workflow logic module governs workflow progression through advancement, repetition, redirection, or termination of workflow steps based on AI validation outcomes.

18. The method of claim 11, wherein the transmitted output data is formatted according to an output schema defined in the selected workflow recipe and is used for at least one of automated grading, archival, or comparison against reference data.

19. A non-transitory computer-readable medium storing instructions that, when executed by a processor, cause the processor to perform a method for remotely configuring, deploying, and executing adaptive, artificial intelligence (AI)-guided, multi-step data capture workflows for physical object verification, the method comprising:
receiving, by the processor, one or more workflow definitions from an authorized administrator through a workflow configuration interface;
storing, by the processor, each workflow definition and corresponding workflow variants as structured recipes in a database;
receiving, by the processor, one or more contextual identifiers, which include at least one of: user ID, object category, fraud risk score, or variant assignment indicator entered by a user for initiating a workflow session;
retrieving, by the processor, a selected workflow recipe from the database based on the contextual identifiers;
determining, by the processor, a dynamic multi-step data capture interface on the computing device using the selected workflow recipe, without requiring application recompilation or update;
displaying, by the processor, per-step instructional content and capture prompts based on the recipe metadata for each workflow step;
capturing and validating, by the processor, one or more user inputs including images, scans, and semi-structured data, using one or more referenced on-device AI models;
determining, by the processor, workflow progression based on validation outcomes and transition conditions defined in the workflow recipe; and
compiling and transmitting, by the processor, the validated data to a server for downstream grading, storage, or reference comparison.
